(19) United States
(12) Patent Application Publication
(10) Pub. No.: US 2011/0186688 A1
(43) Pub. Date: Aug. 4, 2011

(54) Rotating space station torque eliminator

(76) Inventor: Harold James Willard, JR., Washington, DC (US)

(21) Appl. No.: 12/929,471

(22) Filed: Jan. 27, 2011

Related U.S. Application Data
(60) Provisional application No. 61/282,404, filed on Feb. 3, 2010.

(51) Int. Cl. B64G 1/28

(52) U.S. Cl. 244/165

(57) ABSTRACT

This invention uses existing technology to provide a means to initiate and control the rotation of a space station of the type proposed by Werhner von Braun in the 1950s, without the need for an external torque. This is accomplished by creating an angular momentum vector within the hub of the station which is precisely equal and opposite to that of the rest of the station.

### DESCRIPTION OF THE FIGURES

FIG. 1. Photo of rotating space station as conceived by Werhner von Braun to create an artificial gravitational field for astronauts. Model is located in the Air & Space Museum, Washington, D.C.

FIG. 2. Schematic of space station of FIG. 1.

FIG. 3. Cross section B-B of space station of FIG. 2.

FIG. 4. Pod version of rotating space station.

### REFERENCE TO PRIOR APPLICATION

Provisional Patent Application filed Feb. 3, 2010; Application No. 61/282,404; Confirmation No. 2847

### REFERENCES CITED

1. Neufield, Michael J., Von Braun, Dreamer of Space, Engineer of War, Vintage Books, NY, 2007.

### BACKGROUND OF THE INVENTION

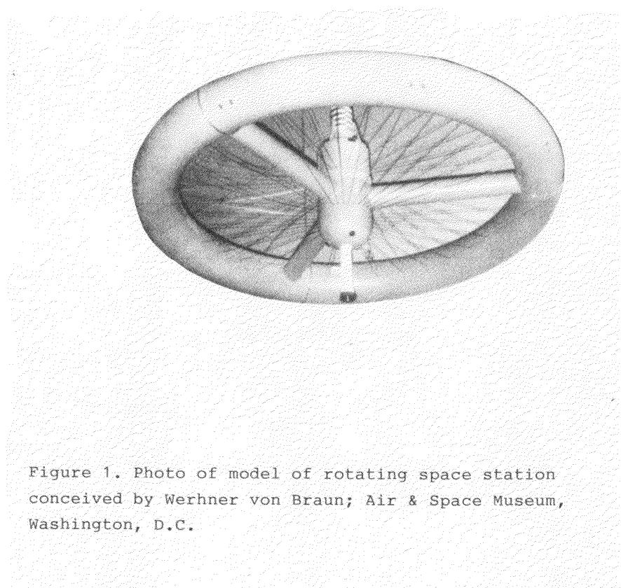

The muscular and skeletal health of astronauts deteriorates with time in the absence of a gravitational field. To offset such effects, Werhner von Braun, pioneering rocket designer for the United States in the 1950s, proposed a design for a rotating space station in which an artificial gravitational field is created via centrifugal force (Reference 1). FIG. 1 is a photo of a model of von Braun's concept, now on display in the Air & Space Museum in Washington, D.C.

A problem associated with such a design is the need to provide an external torque to initiate and control the rotation. The use of small rocket engines requires that fuel be provided to operate the rockets, which must be transported from earth, a costly and time consuming activity which could be hazardous in times of emergency.

The present invention provides a means for precise control of the rotation of the space station without the need for an external force and therefore without the need for fuel to be supplied to rocket engines. Energy to control the rotation can be supplied by electrical power produced through solar panels or other sources affixed to the station itself. This is accomplished by creating an angular momentum vector within the hub of the station which is precisely equal and opposite to that of the rotating station, thereby nullifying the need for an external torque.

With this invention, a variable gravitational field can be produced for scientific or engineering purposes, or for manufacturing processes which are enhanced by the absence of a gravitational field.

### SUMMARY OF THE INVENTION

This invention creates an angular momentum vector within the hub of a rotating space station which exactly cancels that of the rotating station itself. This eliminates the need for an external torque to be applied to the station to initiate and control its rotation, and thereby eliminates the need for fuel to be supplied for rockets to provide the necessary thrust.

This invention employs a very heavy cylinder, made of a high density metal such as uranium, tungsten or tantalum, rotated by gears within the hub in a direction opposite to that of the station such that the angular momentum vector of the rotating cylinder precisely cancels that of the rotating station.

### DETAILED DESCRIPTION OF THE INVENTION

In the following discussion, the sizes selected for the various components and quantities are to demonstrate that the principles of the invention are valid. Although they do not necessarily apply to a particular space station design, they do approximate those for the station of FIG. 1, as discussed in Reference 1.

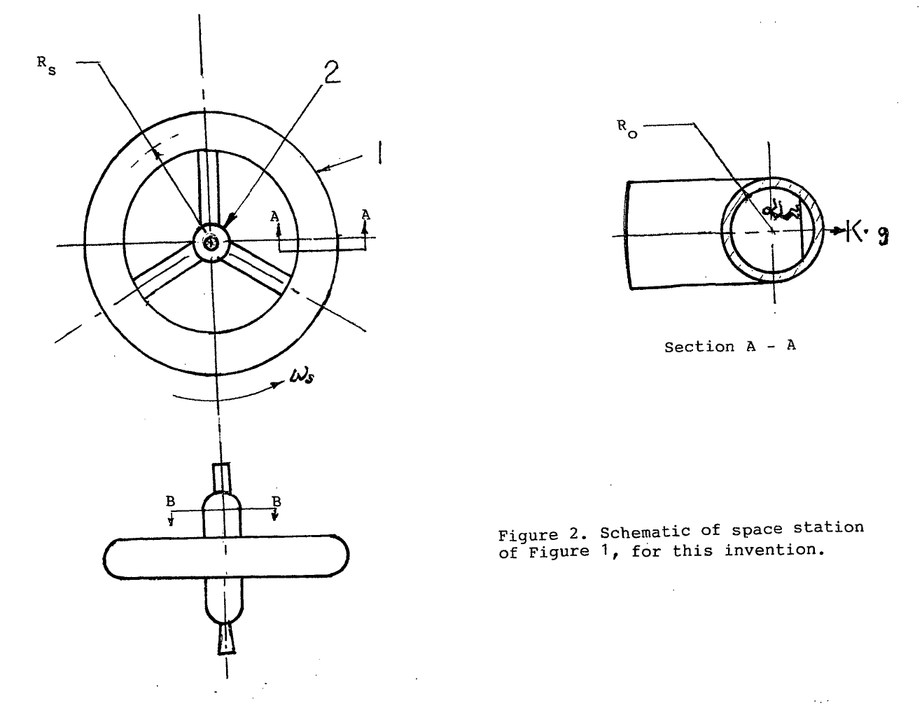

FIG. 2 is a schematic of the space station of FIG. 1. With a mean radius of the ring (1) of 50M, the angular velocity required to produce an equivalent gravitational force at the center of the ring equal to k·g (0≦k≦1) is

$$\begin{matrix}s = \sqrt{k \cdot g / {R}_{s}} \\ = .443 \sqrt{k} / s ( 4.23 \sqrt{k} rpm )\end{matrix} \qquad Eqn . ( 1 )$$

Here g is the acceleration of gravity on Earth (9.8M/s²); k is a constant.

The mass of the space station is estimated to be

$$\begin{matrix}{m}_{s} = {ρ}_{s} \cdot 2 π {R}_{s} \cdot π {R}_{O}^{2} \\ = 2.418 E 7 KG\end{matrix} \qquad Eqn . ( 2 )$$

In Equation 2, [symbol] is the density of the outer ring estimated to be about twice that of water, 2.0 KG/M³; Rₛ is the mean radius of the ring (50M), which for this approximation is assumed to hold essentially all of the mass; Rₒ is the radius of the cross section of the ring, assumed to be 3.5M.

The angular momentum of the station with respect to its center is, for k=1.0,

$$\begin{matrix}\vert {\overline{J}}_{s} \vert = \vert {I}_{s} \cdot {w}_{s} \vert \\ = {m}_{s} \cdot {R}_{s}^{2} \cdot {w}_{s} \\ = 2.68 E 10 KG \cdot {M}^{2} \cdot \text{/} s\end{matrix} \qquad Eqn . ( 3 )$$

A torque is required to produce an angular momentum and to maintain it in the presence of friction or other losses. However, if the angular momentum vector of the system can be made to be zero, no net external torque is required. Thus the torque, T̅,

$$\begin{matrix}\begin{matrix}\overline{T} = \frac{d}{d t} ( {\overline{J}}_{s} + {\overline{J}}_{c} ) \\ = 0\end{matrix} \\ if & Eqn . ( 4 ) \\ {\overline{J}}_{s} = - {\overline{J}}_{c} & Eqn . ( 5 )\end{matrix}$$

where J̅_{c} is the vector angular momentum of a device within the hub (2) which exactly equals and is opposite to that of the rotating station.

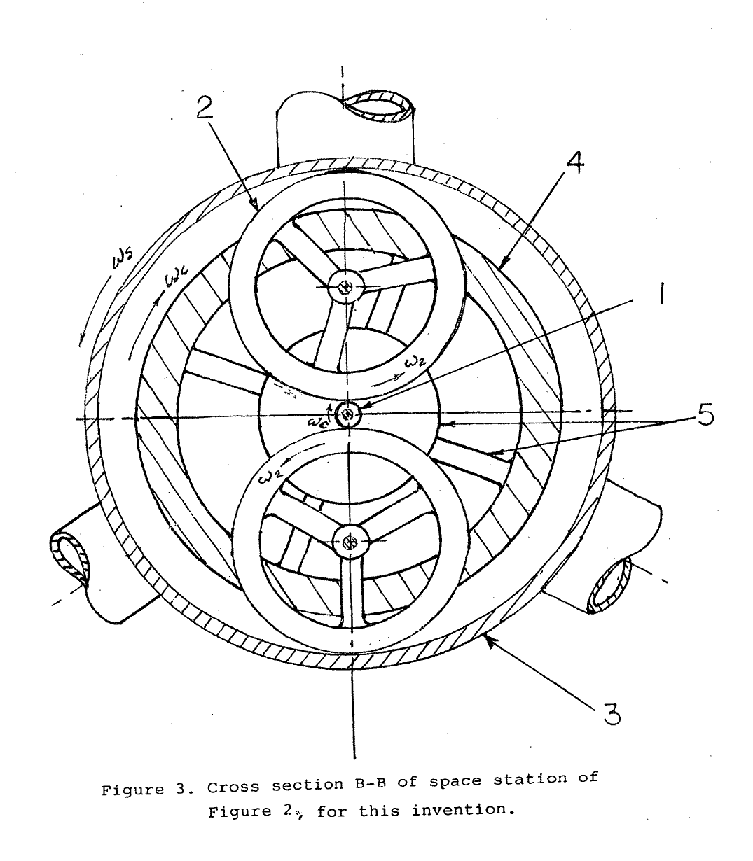

In this invention, the counteracting angular momentum vector is created by rotating a high density cylinder about the center of the station in a direction opposite to the rotation of the outer sing through a system of gears, shown schematically in FIG. 3. It is understood that a practical system will require bearings, shafts and supports, as is common in the art, as well as variable speed motors, powered by a source affixed to the station or otherwise configured to supply the necessary power for this system. The cylinder (4), which may be called the “Angel” (Angular Momentum Eliminator) is attached to the central drive shaft (1) through the supporting structure (5). In order to minimize its size, it should be made of a high density metal, such as uranium, tungsten or tantalum, which have densities about twenty times that of water.

A limitation on the allowable angular velocity of the cylinder exists through the maximum allowable stress in the outer surface, τₜ,

τₜ=ω_{c}·R_{c}²·w_{c}² Eqn. (6)

If this stress is limited to 2E8 N/M² (29,000 psi),

$$\begin{matrix}{R}_{c} \cdot {w}_{c} = \sqrt{\frac{{σ}_{t}}{{ρ}_{c}}} \\ = 1 E 2 M \cdot rad \text{/} s\end{matrix} \qquad Eqn . ( 7 )$$

For a cylinder of mean radius 10M, its angular velocity is, from Eqn. (7), equal to 10 rad/s (95.5 rpm).

To determine the wall thickness of the “Angel” (cylinder), Eqn. (5) yields

I_{c}·w_{c}=Iₛ·wₛ Eqn. (9)

[symbol]

·2π·R_{c}·ΔR_{c}·L·R_{c}²·w_{c}=2.68E10 KG·M²·rad/s Eqn. (10)

from Eqn. (3). For a cylinder of length, L, of 10M, ΔR_{c}=2.13M.

To determine the sizes of gears required to produce an angular rotation of 4.23 rpm in the ring and 95.5 rpm in the opposite direction in the cylinder, consider FIG. 3:

R₁w₁=R₂w₂=R₃w₃ Eqn. (11)

in which R₁, R₂, R₃ are the radii of the pinion, planetary and ring gears, respectively, and w₁, w₂, w₃ are the corresponding angular velocities.

Since the pinion is affixed to the cylinder, w₁=w_{c}. Ring gear (3) is part of the hub, therefore, w₃=wₛ, which determines the radius of the pinion, if R₃ is fixed. For R₃=12M,

$$\begin{matrix}{R}_{1} = \frac{{w}_{c}}{{w}_{s}} \cdot {R}_{s} \\ = .531 M\end{matrix} \\ s - 6 \qquad Eqn . ( 12 )$$

Since,

R₁+2·R₂=R₃, Eqn. (13)

it follows that R₂=5.73M.

Two planetary gears (2) are used to balance forces on the pinion and to provide redundancy to the system. These gears, affixed to the support structure for the pinion rotate about their own axes and thereby impart a rotation to the outer ring which is in the reverse direction of the cylinder (affixed to the pinion). Since

$${R}_{2} \cdot {w}_{2} = ( 2 {R}_{2} + {R}_{1} ) \cdot {w}_{3} \\ {W}_{2} = ( 2 + \frac{{R}_{1}}{{R}_{2}} ) \cdot {w}_{s} \qquad Eqn . ( 14 )$$

The angular momentum of the outer ring of the station is precisely equal and opposite to that of the “Angel”, the inner cylinder. The planetary gears rotate about twice as fast as the station. Starting the system by imposing a rotation on the pinion produces an equal and opposite angular momentum in the station, nullifying the need for an external torque.

It is evident that this system may be driven by motors driving the pinion or the planetary gears, or to all three to provide backup for emergency conditions or to reduce the power required by any one motor.

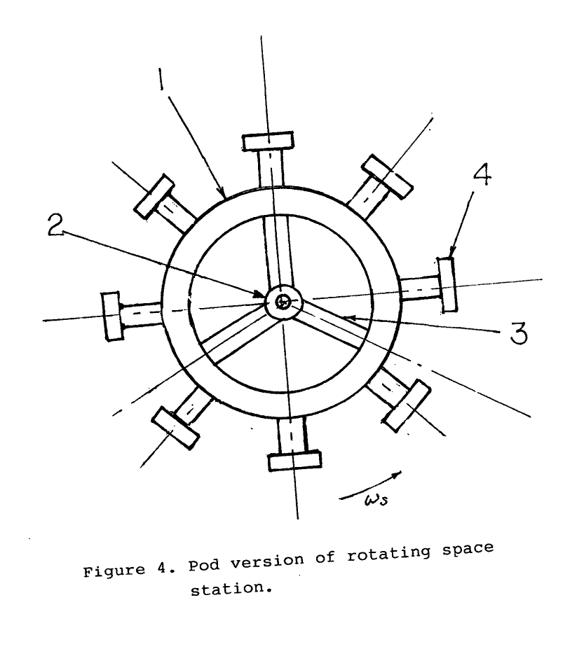

The “Angel” system is not limited to the von Braun space station design of FIG. 1. Other configurations which use rotation to produce/ [symbol] tificial gravitational field are also amenable to this invention. For example, a pod version of a rotating space station is shown in FIG. 4. It is similar to the von Braun configuration in that a rotating ring (1), a central hub (2), and connecting tubes (3) are present, but differs in that pods (4) are affixed to the ring. These pods could provide individual stations to be operated by nations, universities, or corporations performing research or manufacturing tasks. Being detachable, they could be removed in the event of a major accident in any one and replaced. As individual units, they allow for privacy for the users.

This system for counteracting start-up torque is not limited to space stations, or situations in which a gravitational field is absent. It may be applied to the rotation of other devices with or without a gravitational field present in situations (e.g. in an ocean facility), in which a stabilizing platform to produce a counter-acting counter-torque is not available.

1. A system is created to initiate and control the rotation of a space station of the type proposed by Werhner von Braun in the 1950s, without the need for an external torque. This is accomplished by creating an angular momentum vector within the hub of the station which is precisely equal and opposite to that of the rest of the station.

2. The system created allows precise and continuous control of the rotational velocity such that a particular magnitude of an artificial gravitational field may be produced.

3. The system created may be applied to the rotation of other devices with or without a gravitational field present in situations in which a stabilizing platform to produce a large counter-torque is not available.
